(19) United States
(12) Patent Application Publication
(10) Pub. No.: US 2006/0118030 A1
(43) Pub. Date: Jun. 8, 2006

(54) Bookmark

(76) Inventor: Matthew Daley, Orlando, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/293,437

(22) Filed: Dec. 2, 2005

Related U.S. Application Data
(60) Provisional application No. 60/633,411, filed on Dec. 3, 2004.

(51) Int. Cl. B42D 9/00

(52) U.S. Cl. 116/234

(57) ABSTRACT

A bookmark has a compartment for storing an article for use by a reader. The bookmark preferably comprises a lower section that is capable of being placed between pages of a book, and an upper section that protrudes from a periphery of a book or pages of a book. At least a portion of the lower section forms the compartment that holds the article, and the compartment can be opened to access and retrieve the article. In addition, the upper section or lower section may contain data entry lines for inputting data relative to the book and person reading the book.

### CROSS-REFERENCE TO RELATED APPLICATIONS

This application claims the benefit of the U.S. provisional application, Application No. 60/633,411, filed Dec. 3, 2004.

### BACKGROUND OF THE INVENTION

This invention relates in general to bookmarks. More particularly, the invention pertains to bookmarks that have been adapted to provide multiple purposes beyond serving as a mark for a page in a book, magazine, journal or the like.

Bookmarks primarily serve the purpose of marking the page or pages for a person reading a book, magazine, journal or the like. The bookmark may take the form of various shapes or sizes. Primarily bookmarks have a lower portion that is inserted between pages of a book, and an upper portion connected to the lower portion that extends beyond a periphery of the pages of the book. With such a configuration, when a person stops reading a book, the reader places the bookmark in a desired position on the page being read and closes the book. Having the upper portion protruding beyond the periphery of the book enables the reader to readily locate the page on which the person stopped reading.

Ben-Dor et al., in U.S. Pat. No. 6,722,309, discloses a bookmark that may serve another purpose other than simply marking a page in a book. The bookmark has an upper hook-like section that rides over the binding of a book, and acts as an “attention-attracting” item, such as pencil sharpener, photograph or advertising piece which may be attached to the hook-like section. The '309 patent also mentions that the bookmark itself may be formed of a suitable candy substance. Accordingly, the use of the bookmark as a candy substance raises sanitary issues.

### BRIEF DESCRIPTION OF THE INVENTION

The present invention is for a bookmark having a compartment for storing an article for use by a reader. The bookmark preferably comprises a lower section that is capable of being placed between pages of a book, and an upper section that protrudes from a periphery of a book or pages of a book. At least a portion of the lower section forms the compartment that holds the article, and the compartment can be opened to access and retrieve the article. In addition, the upper section or lower section may contain data entry lines for inputting data relative to the book and person reading the book.

In one embodiment, the upper section is attached in sealing relationship to the lower section forming a pocket or pouch-like configuration forming the compartment in the lower section. The upper section may be separable from the lower section to open the compartment. Alternatively, the lower section may include a means for opening the compartment and/or closing the compartment. The bookmark may be disposable, or if the compartment can be closed, the bookmark can be reused.

In another embodiment, the upper section and lower section are integrally connected forming a compartment that extends an entire length of the bookmark. The bookmark includes means, operatively connected to the upper section and/or the lower section for opening and/or closing the compartment.

The invention is ideally suited for children, but not limited to use by children. The invention provides a reward for a child reader upon completion of a book. Once a child finishes reading a book the lower section is separated from upper section and/or the compartment is opened to retrieve the article. In addition, the child and/or parent of the child, may record on the bookmark the name of the child, the title of the book and the date the child completed reading the book. The bookmark of the present invention also provides a sanitary delivery system in the case the article is an edible insert used with the bookmark.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a front elevational view of an embodiment of the bookmark according to the present invention.

FIG. 2 is a side elevational view of an embodiment of the bookmark according to the present invention.

FIG. 3 is a perspective view of a book in which the bookmark according to the present invention is placed.

FIG. 4 is a front elevational view of an embodiment of the bookmark according to the present invention having an insert being retrieved from the bookmark.

FIG. 5 is a front elevational view of an embodiment of the bookmark according to the present invention having an insert being retrieved from the bookmark.

FIG. 6 is a front elevational view of an embodiment of the bookmark according to the present invention.

FIG. 7 is a front elevational view of an embodiment of the bookmark according to the present invention having an insert being retrieved from the bookmark.

FIG. 8 is a rear elevational view of an embodiment of the bookmark according to the present invention having an insert being retrieved from the bookmark.

FIG. 9 is a side elevational view of the embodiment shown in FIG. 8.

### DETAILED DESCRIPTION OF THE INVENTION

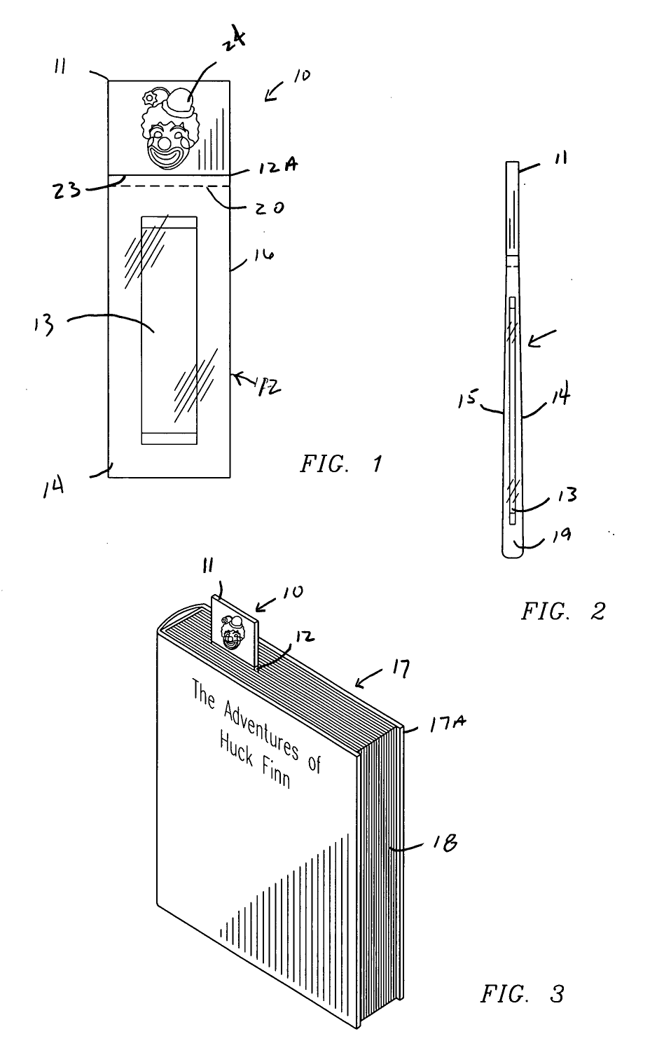

An embodiment of the invention is illustrated in FIGS. 1 through 4. The bookmark 10 shown in FIG. 1 includes an upper section 11 and lower section 12. At least a portion of the lower section 12 is inserted between pages 18 of a book 17. As shown in FIG. 3 at least a portion of the upper section 11 extends or protrudes beyond a periphery defined by the outer edges of pages 18 or the outer edge 17A of the book 17.

With respect to FIGS. 1 and 2, the lower section 12 is preferably formed as a pouch-like configuration for receiving the article 13. In an exemplary embodiment, the lower section 12 includes a front panel 14 and back panel 15 attached in sealing relationship with one another. The panels 14 and 15 may be sealed along an outer edge 16 to form a compartment 19 for receiving the article 13. The panels 14 and 15 may also be a single piece of material folded over and the edges of the material are sealed with an appropriate adhesive to form the compartment. The invention is not intended to be limited to this particular configuration or shape of the lower section 12, but may include any shape or assembly that forms a compartment for receiving a useful article for a reader. The lower section 12 is preferably composed of a transparent thin plastic or cellophane material. However, the lower section 12 does not have to be transparent and can be composed of materials such as a thin paper, foil or any material. If the bookmark 10 is disposable, the material selected for the lower section 12, should be thin enough to easily tear open or so the lower section 12 may be separated from the upper section 11 to retrieve the article 13 as explained below in more detail.

The article 13 may take the form of any item that can fit within the compartment 19. For example, the article 13 may include edible items such as gumsticks, fruit rollups or the like or paper items providing game pieces, coupons, promotional pieces, etc. The article 13 is preferably thin and not bulky such that the book cannot be closed when not in use.

A top end 12A of the lower section is preferably attached in sealing relationship to the upper section 11, forming a seal 23 between the upper section 11 and the lower section 12, to encase the article 13 within the lower section 12. The bookmark 10 may include means for separating the lower section 12 from the upper section 11 in order to open the compartment 19 to retrieve the article 13. For example, the upper section 11 may be comprised of the same material as the lower section 12 and a perforation 20 is formed on the seal 23 or below the seal 23 on the lower section 12. Alternatively, a tab (not shown) may be attached to the seal 23 to pull and break the seal 23 between the upper section 11 and lower section 12 for opening the compartment 19. In such cases the lower section 11 and/or upper section 12 may be disposable.

The invention is not limited to a disposable bookmark, but may include a bookmark that is reusable. With respect to FIG. 5, an embodiment is shown in which the compartment 19 in the lower section 12 has means for opening and closing the compartment 19. The lower section 12 may include an open/close mechanism 21, such as a zip-lock, an adhesive flap, small button/snap mechanism, hook and loop mechanism (Velcro®) or any other simple open and closure mechanism that can be attached to the lower section 12. The opening and closing means may be disposed below the top section 11 on the top end 12A of the lower section 12, along the sides or bottom of outer edge 16.

The upper section 11 may have a fanciful character 24 or design printed on one or both sides of the upper section 11. Alternatively, a character or design may be printed on a separate piece of material, which is adhered to the upper section 11. In another embodiment, the upper section 11 of the bookmark 10 may include a logo of a manufacturer and/or distributor of the article 13.

The upper section 11 may be composed of a material that is different than the material making up the lower section 12. For example, the upper section 11 may be a cardstock paper, cardboard, plastic or any material to which the lower section 12 can be attached. However, as noted above, the upper section 11 may also be composed of the same material comprising the lower section 12.

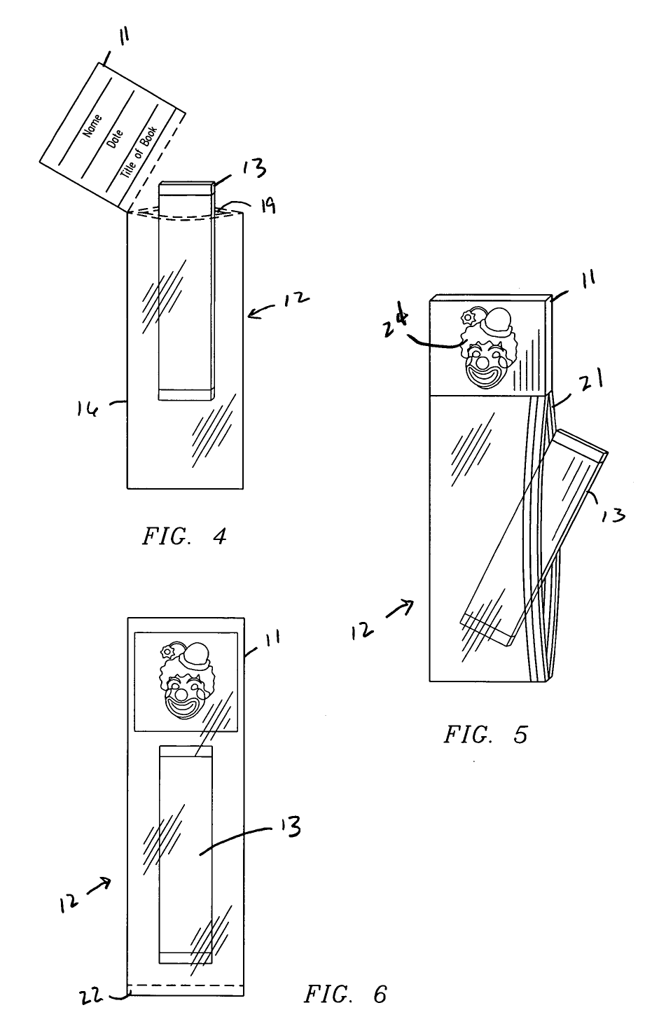

In the embodiments illustrated in FIG. 4, data entry lines 24 are provided on the upper section 11 of the bookmark 10. These data entry lines 24 may be printed directly on the sections 11 and 12 or on cards that can be adhered to the sections 11 or 12 and can be removed from or attached to the bookmark 10. The data entry lines 24 provide space to record information about the reader and/or the book, such as name of the reader, the title of the book, and the date the reader completed reading the book. After the reader completes the book, the above referenced information can be recorded on the available space and bookmark 10 or sections 11 and 12 containing the information and stored as a keepsake. In the case where the bookmark is reusable, and on which a card containing the data entry lines 24 is attached to the bookmark 10, the card can be removed and another card with data entry lines 24 is attached to the bookmark 10 for later use.

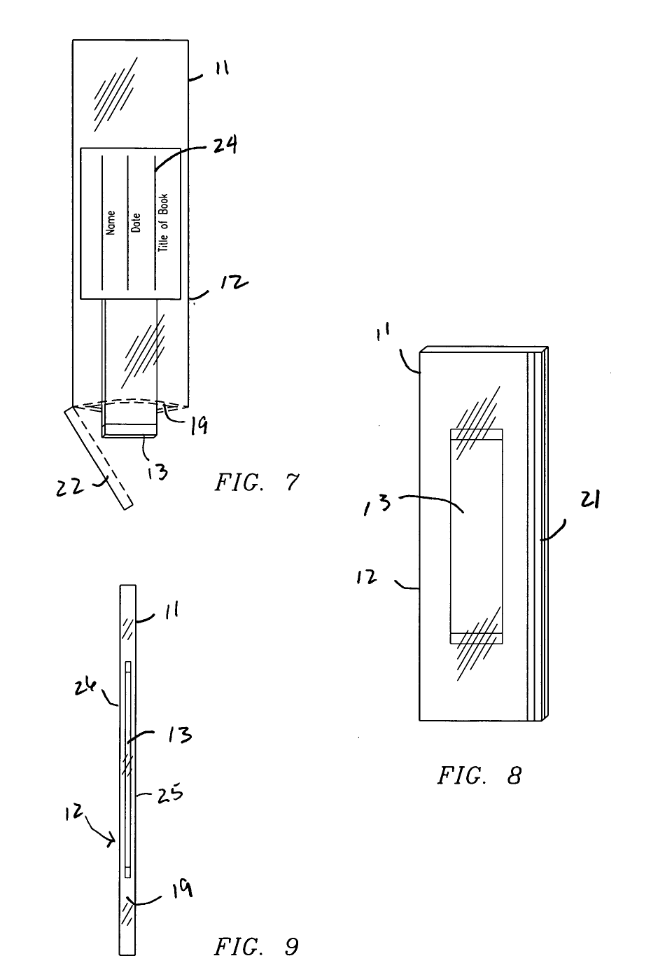

With respect to FIGS. 6 and 7, an embodiment is shown in which the lower section 12 has a disposable tab 22 distal to the upper section 11. When the child finishes reading the book, the disposable tab 22 is removed to obtain the article 13. Space for historical information is provided on the lower section 22, as shown in FIG. 7, so the upper section 11 and lower section 12 are retained for recording the child's accomplishment. As described above, a card having space for recording the historical data can be removably attached to the bookmark 10. When the child finishes the book, the parent records the data or information and removes the card and replaces it with another for later use.

Another embodiment of the invention illustrated in FIGS. 8 and 9 comprises a bookmark 10 in which the compartment 19 extends from the upper section 11 to the lower section 12. A seal does not separate the upper section 11 and lower section 12, so the compartment 19 may extend an entire length of the bookmark 10. As shown in FIG. 9, the bookmark 10 includes a front panel 25 operatively connected to, and preferably sealed to a back panel 26 forming the compartment 19, in which the article 13 is stored. An indicia or data entry lines may be printed onto, or attached to the sections 11 and/or 12 as described above.

The bookmark 10 preferably includes a means for opening the compartment 19 to retrieve the article 13. The embodiment shown in FIGS. 8 and 9 is a reusable bookmark 10, so the opening means may include the above described closure mechanisms to open and close the compartment 19. Alternatively, the bookmark may be disposable and include a perforation for tearing open the compartment 19. The bookmark 10 may be composed of a separable material, such as paper, plastic or cellophane, that can be torn to open the compartment.

The invention is ideally suited for children, but not limited to use by children, wherein the bookmark 10 provides a reward for a child reader upon completion of a book 17. As shown in FIG. 4, once a child finishes reading a book the lower section 12 is separated from upper section 11 and/or opened to retrieve the article 13, which may be an edible insert. The lower section 12 and upper section 11 may be disposed of, if the bookmark is of a disposable nature as described above. In the embodiments shown in FIGS. 4 and 7, upper section 11 or lower section 12 have space available for recording the child's accomplishment. For example, the child and/or parent of the child, may record the name of the child, the title of the book and the date the child completed reading the book. For those embodiments in which the bookmark 10 is reusable, the parent can fill the compartment 19 with another article 13 for later use.

While the preferred embodiments of the present invention have been shown and described herein, it will be obvious that such embodiments are provided by way of example only and not of limitation. Numerous variations, changes and substitutions will occur to those skilled in the art without departing from the teaching of the present invention. Accordingly, it is intended that the invention be interpreted within the full spirit and scope of the appended claims.

I claim as my invention:

1. A bookmark for locating a desired page in a readable item, comprising:
a lower section at least a portion of which is insertable between pages of a readable item;
an upper section attached to the lower section, and at least a portion of the upper section protruding from a periphery defined by outside edges of pages of the readable item; and,
a compartment operatively connected to the lower section for holding an article for use by a reader of the readable item.

2. The bookmark of claim 1 further comprising means, operatively connected to the lower section, for opening the compartment.

3. The bookmark of claim 1 wherein the bookmark is composed of a material that can be torn to open the compartment.

4. The bookmark of claim 1 wherein the upper section is attached in sealing relationship to the lower section and the lower section is separable from the upper section to open the compartment.

5. The bookmark of claim 4 further comprising a seal between the upper section and the lower section and a perforation between the upper section and lower section for separating the lower section from the lower section to open the compartment.

6. The bookmark of claim 1 further comprising means, connected to the lower section, to open and close the compartment.

7. The bookmark of claim 1 wherein the lower section includes a tab positioned at an end of the lower section distal the upper section, and the tab is separable from the lower section to open the compartment.

8. The bookmark of claim 1 further comprising data entry spaces on the upper section or the lower section.

9. A bookmark for locating a desired page in a readable item, comprising:
a front panel attached in sealing relationship to a back panel forming a compartment there between for holding an article for use by the reader.

10. The bookmark of claim 9 further comprising a lower section at least a portion of which is insertable between pages of a readable item an upper section attached to the lower section, and at least a portion of the upper section protruding from a periphery defined by outside edges of pages of the readable item.

11. The bookmark of claim 10 wherein the upper section is attached in sealing relationship to the lower section, and the front panel and back panel form the lower section, and the upper section and lower section are separable from one another to open the compartment.

12. The bookmark of claim 10 wherein the upper section is attached in sealing relationship to the lower section and having a seal there between, and the front panel and back panel forming the lower section, and lower section having a means, operatively connected thereon, for opening and closing the compartment.

13. The bookmark of claim 10 further comprising an indicia on the upper section.

14. The bookmark of claim 9 further comprising data entry spaces on the front panel or back panel.

15. The bookmark of claim 9 wherein the bookmark is fabricated from a material that can be torn to open the compartment.

16. The bookmark of claim 11 wherein the lower section includes a tab positioned at an end of the lower section distal the upper section, and the tab is separable from the lower section to open the compartment.

17. The bookmark of claim 11 wherein the front panel and back panel is fabricated from a pliable material that is torn to open the compartment and the compartment is limited to the lower section and upper section is fabricated from a material thicker than pliable material of the lower section.
